(19) United States
(12) Patent Application Publication
(10) Pub. No.: US 2023/0350864 A1
(43) Pub. Date: Nov. 2, 2023

(54) SEMI-MATERIALIZED VIEWS

(71) Applicant: TERADATA US, INC., San Diego, CA (US)

(72) Inventors: Rangavajjula K N Sai Krishna, Hyderabad (IN); Chandrasekhar Tekur, Hyderabad (IN); Bhashyam Ramesh, Secimderabad (IN); Shambhu Sree Vegunta, Begumpet (IN); Venkata Ramana Jyothula, Hyderabad (IN)

(21) Appl. No.: 17/661,066

(22) Filed: Apr. 28, 2022

(51) Int. Cl. G06F 16/2453

(52) U.S. Cl. CPC G06F 16/24539; G06F 16/24537

(57) ABSTRACT

A database system includes a storage medium to store a semi-materialized view (MV) defined on an MV condition, the semi-MV including metadata containing references to objects containing data of one or more tables that satisfy the MV condition, the objects stored in a remote data store that is coupled to the database system over a network. The database system includes at least one processor to receive a query including a query condition, determine that the semi-MV can be used to satisfy the query based on the MV condition and the query condition, and use the metadata in the semi-MV to retrieve data of the objects in the remote data store for the query.

### BACKGROUND

A relational database management system (DBMS) stores databases that include collections of logically related data arranged in a predetermined format, such as in tables that contain rows and columns. To access the content of a table in a database, queries according to a standard database query language (such as the Structured Query Language or SQL) are submitted to the database. A query can also be issued to insert new entries into a table of a database (such as to insert a row into the table), modify the content of the table, or to delete entries from the table. Examples of SQL statements include INSERT, SELECT, UPDATE, and DELETE.

In other examples, object stores can be used to store objects that are usually larger in size than rows of a table in a relational DBMS. The object stores can be provided in a cloud that is accessible over a network, for example.

### BRIEF DESCRIPTION OF THE DRAWINGS

Some implementations of the present disclosure are described with respect to the following figures.

FIG. 1 is a block diagram of an example arrangement that includes a database management system and a remote data store, according to some implementations of the present disclosure.

FIG. 2 is a block diagram of a semi-materialized view according to some examples.

FIG. 3 a flow diagram of an example process according to some implementations of the present disclosure.

FIG. 4 is a block diagram of an example database system according to some implementations of the present disclosure.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

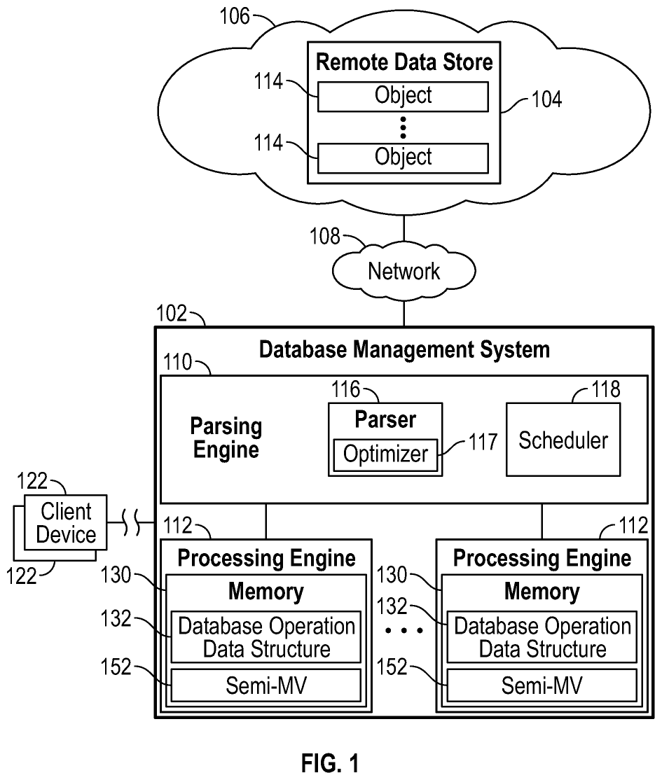

FIG. 1 is a block diagram of an example arrangement that includes a database management system (DBMS) 102 and a remote data store 104. In some examples, the data store 104 is an object store that stores objects 114. As used here, an “object” can refer to any separately identifiable or addressable unit of data.

In some examples, the remote data store 104 can be accessible in a cloud 106. A “cloud” can refer to any infrastructure, including computing, storage, and communication resources, that can be accessed remotely by user devices over a network, such as a network 108 shown in FIG. 1. Alternatively, the data store 104 can be provided in a data center or in any other computing environment.

The network 108 can include a public network (e.g., the Internet), a local area network (LAN), a wide area network (WAN), a wireless network (e.g., a wireless local area the network or WLAN, a cellular network, etc.), or any other type of network.

The DBMS 102 includes a parsing engine 110 that is able to process SQL queries, including data definition language (DDL) statements and data manipulation language (DML) statements.

In addition to the parsing engine 110, the DBMS 102 includes multiple processing engines 112.

As used here, an “engine” (e.g., the parsing engine 110 or a processing engine 112) can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, an “engine” can refer to a combination of a hardware processing circuit and machine-readable instructions (software and/or firmware) executable on the hardware processing circuit.

The multiple processing engines 112 are able to execute in parallel with one another, and are able to access, in parallel, different data portions (e.g., different objects 114, different portions of objects 114) of the remote data store 104. Each processing engine 112 is considered a Unit of Parallelism (UOP) that is able to execute in parallel (e.g., concurrently or simultaneously) with one or more other UOPs. Each UOP is able to perform a local relational operation, such as a join operation (e.g., to join data from multiple tables), a data aggregation operation (to aggregate multiple pieces of data into an aggregate value, such as a sum, maximum, minimum, average, median, etc.), and so forth.

In other examples, the DBMS 102 can include just one processing engine 112.

In some examples, the multiple processing engines 112 include respective different computer nodes. In other examples, the multiple processing engines 112 include respective different processors or cores of multi-core processors.

Traditionally, a DBMS stores data of base tables in a block-based storage, in which data is stored as blocks that are smaller in size than objects of object stores. A “base table” can refer to a relational table of a database created to store specific data records. A base table is differentiated from other data structures that may be used to store a subset of data of one or more base tables, or data derived from data of one or more base tables. Examples of such other data structures include views, materialized views, spools (temporary structures to store data) and so forth.

In some examples, a block-based storage can include disk-based storage devices, solid state storage devices, and so forth. The block-based storage can be connected to the DBMS over a relatively high-speed link, such that the DBMS can access (read or write) data in a relational database with relatively low input/output (I/O) latency (i.e., the delay between a time that a request is submitted and a time that the request is satisfied at the storage is relatively low). The block-based storage can be considered a local storage of the DBMS, since the DBMS is able to access the block-based storage with relatively low I/O latency.

In some examples of the present disclosure, instead of or in addition to coupling block-based storage (that store base tables) to the DBMS 102, the DBMS 102 can work with the remote data store 104, which can be provided in the cloud 106 or another remote computing environment. In such examples, local block-based storage is not used with the DBMS 102 to store base tables.

The objects 114 of the remote data store 104 can have variable sizes, and each object can have a size between 10 megabytes (MB) and 100 MB. In other examples, an object can have a smaller or larger size. An object in an object store is typically larger in size than data records (e.g., rows, tables, etc.) stored in a local block-based storage.

The objects 114 can include objects of multiple base tables, where each object can include rows of a given base table. In some cases, an object can include rows of multiple base tables.

When responding to a database query, the DBMS 102 can access (write or read) data of the remote data store 104, rather than base table data in a relational table (or relational tables) of a local block-based storage. In some examples, accessing data of the remote data store 104 can have a higher 1/O latency than accessing data of a local block-based storage.

Materialized views (MVs) are database objects that contain results of respective queries. An MV can be defined on an MV condition, which includes a predicate that can be defined on one or more columns of one or more base tables. For example, an MV condition can include a join condition, which specifies a join of rows of multiple base tables if a specified predicate is satisfied. For example, the predicate of the join condition that be WHERE T1.A=T2.B and T1.C=9, which means that the rows of base tables T1 and T2 are joined if the predicate column A of table T1 is equal to column B of table T2, and column C of table T1 is equal to 9.

Results (e.g., join results) of queries that satisfy the MV condition are stored in the MV. An MV condition specifies the condition that rows of one or more tables are to satisfy if they are to form part of the result to be stored in an MV.

MVs are provided to enhance query performance, since an MV can be locally stored in a DBMS, such as in a local cache of a processing engine.

An MV that stores data of base table(s) is referred to as a full MV.

The creation of full MVs in conjunction with a remote data store (e.g., 104 in FIG. 1) stored in a cloud or at another remote location can be associated with increased creation and/or maintenance costs. The increased costs are due retrieving the larger objects 114 from the remote data store 104 into the full MV. Retrieving larger objects leads to an increase in consumption of the bandwidth of the network 108, as well as increased consumption of processing and storage resources.

Similarly, as the larger objects 114 in the remote data store 104 are updated, the corresponding updates of full MVs can be expensive in terms of usage of the network, processing, and storage resources.

In accordance with some implementations of the present disclosure, rather than implement full MVs in the DBMS 102, semi-MVs (e.g., a semi-MV 152) can be used in the DBMS 102.

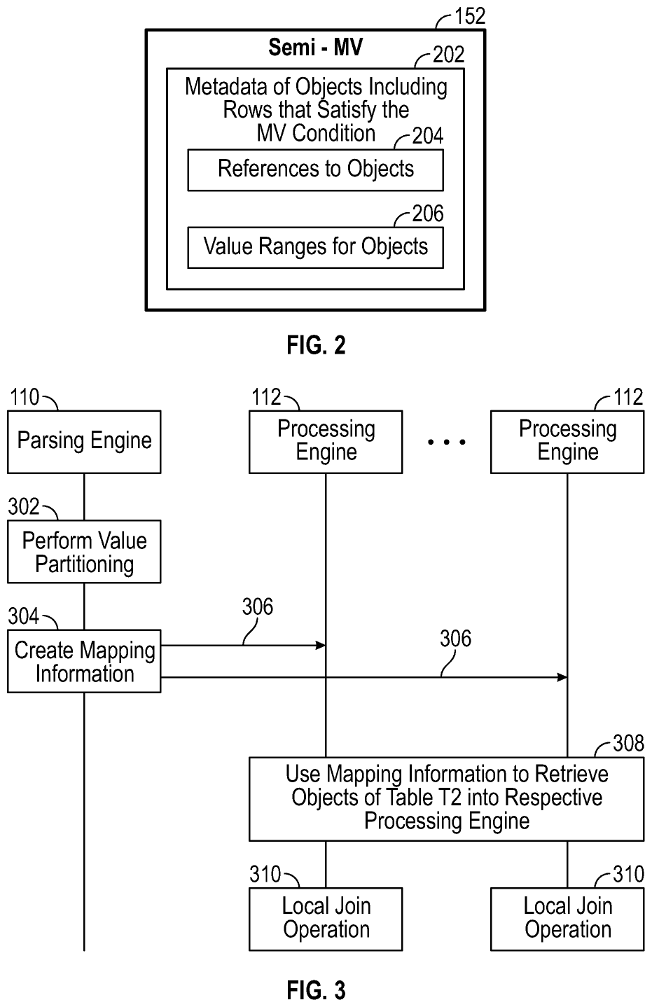

A semi-MV is a lightweight MV that does not actually store data of base tables, and thus, does not materialize data from the base tables. Instead, as further shown in FIG. 2, the semi-MV 152 stores metadata 202 of objects 114 that include rows that satisfy the MV condition. For example, if the MV condition includes WHERE T1.A=T2.B and T1.C=9, then the metadata 202 is of objects 114 that include rows of tables T1 and T2 that satisfy the predicate T1.A=T2.B and T1.C=9.

The metadata can include references 204 to objects 114 of base table(s) that satisfy the MV condition of the semi-MV. A reference to an object 114 can be in the form of location information (e.g., pointers, uniform resource locators (URLs), pathnames, etc.) that refer to a location of the object 114. As another example, a reference to an object 114 can be in the form of an object name, which can uniquely identify the object 114 (i.e., different objects 114 have different object names).

The metadata 202 also includes value ranges 206 for objects 114 containing rows of base table(s) that satisfy the MV condition of the semi-MV 152. Such objects 114 containing rows of base table(s) that satisfy the MV condition of the semi-MV 152 are referred to as “qualified objects” 114.

The value ranges 206 can be in the form of a minimum-maximum value range, in which the range is defined between a minimum value of a column and a maximum value of the column in the rows of the qualified objects 114. The column is a column of rows of a table on which the MV condition is defined. In the example where the MV condition includes a predicate that joins tables T1 and T2 based on T1.A=T2.B, the columns on which the predicate is defined include column A of table T1, column B of table T2.

The value ranges for the qualified objects 114 can be determined based on sampling actual values of column A of table T1, for example. The DBMS 102 can sample rows of the qualified objects 114 of table T1 in the remote data store 104, and based on the sampled rows, the DBMS 102 can derive the minimum and maximum values of column A of table T1. The minimum and maximum values define the value range 206 for qualified objects 114. Sampling rows of the qualified objects 114 can refer to reading a subset (which can be less than all) of the rows of the qualified objects 114.

Note that the semi-MV 152 stores the metadata 202 of the qualified objects 114, and does not store any actual data of base table(s) containing rows that satisfy the MV condition. In other words, the semi-MV does not materialize the data of the base table(s) containing rows that satisfy the MV condition. Unlike a full MV with a list of projected columns containing data of the base table(s), a semi-MV can include columns including metadata. An example of a semi-MV is discussed further below.

As further shown in FIG. 1, the parsing engine 110 of the DBMS 102 can include a parser 116 and a scheduler 118. The parser 116 or scheduler 118 can be part of the hardware processing circuit of the parsing engine 110, or can include machine-readable instructions executable on the parsing engine 110.

The parser 116 receives database queries (such as SQL queries, load requests, etc.) submitted by one or more client devices 122, which may be coupled to the DBMS 102 over an interconnect (e.g., the network 108 or another link). The parser 116 parses each received database query, and generates executable steps for the parsed query. The parser 116 includes an optimizer 117 that generates multiple query plans in response to a query. The optimizer 117 selects the most efficient query plan from among the multiple query plans. Each query plan includes a sequence of executable steps performed to process the database query. The scheduler 118 sends the executable steps of the selected query plan to respective one or more processing engines 112.

Each processing engine 112 manages access of data records in respective objects 114 in the remote data store 104. Each processing engine 112 can perform the following tasks: inserts, deletes, or modifies contents of tables or other data records; creates, modifies, or deletes definitions of tables or other data records; retrieves information from definitions and tables or other data records; locks databases and tables or other data records; and so forth.

As used here, a “data record” can refer to any unit of data that can be written into the remote data store 104. For example, the data record can be in the form of a row of a table, a table, a materialized view, or any other piece of data. Each data record can have multiple attributes. In a table row, the multiple attributes can be the multiple columns of the table row. Each attribute is assigned a value in the corresponding data record.

In some examples where there are multiple processing engines 112, a copy of the semi-MV 152 can be stored in a local memory 130 of each processing engine 112. The local memory 130 can include any or some combination of the following: a volatile memory device, such as a dynamic random access memory (DRAM) device, a static random access memory (SRAM) device, and so forth; a nonvolatile memory device, such as a flash memory device, or any other type of nonvolatile memory device; a disk-based storage device; a solid state storage device; and so forth.

In other examples, the semi-MV 152 can be stored in another storage location that is accessible by each of the processing engines 112.

Certain data of the objects 114 in the remote data store 104 may be accessed frequently, such as in response to the database queries from the one or more client devices 122. To improve performance, metadata for the frequently accessed external data (of the objects 114 and the remote data store 104) can be cached locally at the DBMS 102 in semi-MVs (including the semi-MV 152).

The semi-MV 152 can be created by the parsing engine 110 (or another engine in the DBMS 102 such as a processing engine 112) based on an MV condition.

When a database query is received by the parsing engine 110, the parser 116 can determine whether the semi-MV 152 can be used to satisfy the received database query, based on a comparison of the query condition included in the received query and the MV condition for the MV 152.

Traditionally, in determining whether or not an MV can be used for satisfying a received database query, a parser determines if the MV condition completely overlaps with the query condition; in other words, the data coverage of the MV condition is a superset or is the same as the data coverage of the query condition. The “data coverage” of a query condition or an MV condition refers to a set of data records that satisfy the respective query condition or MV condition.

If the MV condition does not completely overlap with the query condition, then the traditional parser would not be able to use the MV, and will retrieve data from the remote data store 104, which can have a relatively high I/O latency. The high I/O latency can cause a delay in providing results for the database query, can lead to increased network traffic over the network 108, and can cause other issues.

In accordance with some examples of the present disclosure, the optimizer 117 of the parser 116 can make a determination that the semi-MV 152 can be used to satisfy the database query even if the MV condition does not completely overlap with the query condition of the received database query. More generally, the semi-MV 152 is qualified (i.e., the semi-MV 152 can be used to satisfy the database query), if any of the following coverage conditions is met: Condition 1) the data coverage of the query condition is a subset of the MV condition; Condition 2) the MV condition is a subset of the query condition; or Condition 3) the data coverage of the MV condition intersects with the data coverage of the query condition (i.e., the intersection of the data coverage of the MV condition and the data coverage of the query condition is not null).

For Conditions 2 and 3, the partial data for the received database query that cannot be satisfied using the semi-MV 152 is retrieved from the remote data store 104. Since the semi-MV 152 can be used to partially satisfy the database query, query performance is improved since not all data for the database query has to be retrieved from the remote data store 104.

Table 1 below provides an example of content of the semi-MV 152. Assume the semi-MV 152 is defined for an MV condition that specifies a join of tables T1 and T2. The rows of table T1 are stored in 100 objects o₁¹, o₂¹, . . . , o₁₀₀¹ of table T1, with each object including X rows, where X depends on the number of rows of table T1. Similarly, the rows of table T2 are stored in the 100 objects o₁², o₂², . . . , o₁₀₀² of table T2.

The semi-MV 152 shown in Table 1 can include metadata as set forth in Table 1.

TABLE 1

| Row | | |
|---|---|---|
| Number | Objects of T1 | Objects of T2 |
| 1 | References of o₁¹, o₄₉¹, o₈₇¹ | References of o₂², o₄² |
| 2 | References of o₅₁¹, o₆₈¹ | References of o₂₁², o₇₈², o₉₇² |
| 3 | References of o₈₈¹, o₄₀¹ | References of o₆₄², o₂₉² |
| 4 | References of o₃₂¹, o₄₅¹, | References of o₅₆², o₈₆², o₉₉² |
| | o₆₁¹, o₉₁¹ | |

The example semi-MV 152 includes multiple rows, where each row includes an Objects of T1 column containing references to objects of table T1, and an Objects of T2 column containing references to objects of table T2.

For example, in row 1 of the semi-MV 152, the Objects of T1 column contains references to objects o₁¹, o₄₉¹, o₈₇¹ of table T1, and the Objects of T2 column contains references to objects o₂², o₄² of table T2. Row 1 of the semi-MV 152 indicates that rows of the objects o₁¹, o₄₉¹, o₈₇¹ of table T1 are to be joined with rows of the objects o₂², o₄² of table T2.

Similarly, row 2 of the semi-MV 152 indicates that rows of the objects o₅₁¹, o₆₈¹ of table T1 are to be joined with rows of the objects o₂₁², o₇₈², o₉₇² of table T2.

More generally, each row of the semi-MV 152 (that is based on an MV condition that specifies a join of multiple tables) contains metadata identifying rows of objects of the multiple tables that are to be joined.

If the semi-MV 152 is defined on an MV condition that specifies a join of more than two tables, then additional column(s) can be added to the semi-MV 152 that contains references to additional table(s).

In some examples, the rows of a semi-MV can be in a denormalized table format or in semi-structured formats such as JavaScript Object Notation (JSON), eXtensible Markup Language (XML), and so forth.

In determining whether a given object 114 of the remote data store 104 is a qualified object (i.e., the object contains at least one row of a table that satisfies the MV condition), once the DBMS 102 determines that any row in the given object 114 satisfies the MV condition, then the given object 114 is identified by the DBMS 102 as a qualified object without having to scan (read) the rest of the given object 114.

Use of semi-MVs can be associated with one or more of the following benefits, in some examples.

The DBMS 102 just has to look at the predicate of the MV condition to determine whether or not a semi-MV qualifies for use in satisfying a database query, without having to consider what column(s) of table(s) is (are) projected (since the semi-MV does not contain data of any columns of the table(s).

Also, creating and maintaining semi-MVs is associated with reduced use of resources, since the semi-MVs do not actually store data of objects 114.

In some examples, a semi-MV can be used in conjunction with a full MV.

FIG. 3 is a flow diagram of process of using a semi-MV in a join operation, according to some examples.

The process of FIG. 3 assumes that the semi-MV is defined on an MV condition that specifies a join of tables T1 and T2.

The parsing engine 110 (or another engine of the DBMS 102 such as a processing engine 112) performs (at 302) value partitioning based on sampling data of rows of table T1 that satisfy the MV condition. Table T1 can also be referred to as a probe table (or left table) of the join operation. The value partitioning creates (at 304) mapping information that assigns different value ranges to respective processing engines 112 (FIG. 1). The value ranges refer to ranges of values of a column (or multiple columns) of the probe table (table T1). For example, if the MV condition includes the predicate WHERE T1.A=T2.B and T1.C=9, then the value ranges are of column A in table T1.

The value partitioning is performed to assign different rows of qualified objects 114 to different processing engines 112 (based on the value ranges) so that local join operations can be performed by each of the processing engines 112.

The mapping information includes value ranges determined based on values of a column of the probe table (table T1). The mapping information can be provided (at 306) by the parsing engine 110 or another engine to each of the processing engines 112, for example.

The mapping information is used by the processing engines 112 to retrieve (at 308) objects of table T2 (also referred to as a lookup table or a right table) into corresponding processing engines 112, so that a local join operation can be performed (at 310) by each processing engine 112.

A local join operation (or more generally, a local database operation) performed by a given processing engine 112 involves operations on data retrieved into the given processing engine 112. A local join operation would not involve data exchanged between different processing engines 112. For example, the given processing engine 112 can perform a local database operation performed on data retrieved (such as from qualified objects 114 from the remote data store 104) into the local memory 130 of the given processing engine 112. A local join operation is performed on data of multiple tables retrieved into the local memory 130.

Each processing engine 112 has a corresponding local memory 130. The local memory 130 can store a database operation data structure 132 that contains data that is subject to the database operation performed by the processing engine 112. As an example, the database operation data structure 132 can include a hash table used in a hash join operation.

In a specific example, the DBMS 102 has 4 processing engines PE1, PE2, PE3, and PE4. Based on values of column A of table T1 (the probe or left table), the mapping information created can assign the following value ranges (ranges of values of column A) to corresponding processing engines 112: processing engine PE1 is assigned value range 1 to 100; processing engine PE2 is assigned value range 101 to 200; processing engine PE3 is assigned value range 201 to 300; and processing engine PE4 is assigned value range 301 to 400.

In a first example, the metadata 202 (FIG. 2) of the semi-MV 152 can include a value range of 120 to 180 (values of column B in table T2) for a given object. In this first example, the value range for the given object falls in the assigned value range for processing engine PE2. As a result, processing engine PE2 retrieves rows of the given object into the local memory 130 of processing engine PE2. As noted above, the semi-MV 152 can be stored in the local memory 130 of each processing engine. Alternatively, the semi-MV 152 can be stored in a remote storage location that is accessible by each processing engine. Using the value ranges in the metadata 202 in the semi-MV 152, each processing engine can determine which objects to retrieve into the processing engine's local memory 130.

In a second example, the metadata 202 of the semi-MV 152 can include a value range of 150 to 350 (values of column B in table T2) for a given object. In this second example, the value range of 150 to 350 falls into the assigned value ranges for processing engines PE2, PE3, and PE4. Each of processing engines PE2, PE3, and PE4 reads the same given object, but each processing engine PE2, PE3, or PE4 performs a respective local join operation on respective different subsets of rows of the given object. More specifically, processing engine PE2 performs a local join operation on rows of the given object where values of column B of table T2 fall in the range 150 to 200, processing engine PE3 performs a local join operation on rows of the given object where values of column B of table T2 fall in the range 201 to 300, and processing engine PE4 performs a local join operation on rows of the given object where values of column B of table T2 fall in the range 301 to 350.

As noted above, in an example, the database operation data structure 132 can be a hash table used in a hash join operation. A hash join operation builds a hash table from the rows of one of the joined tables (e.g., the probe or left table T1). During the join operation, each processing engine reads the probe table's objects, and writes rows of those objects into the hash table until all rows have been retrieved or the hash table fills up. The processing engine records the minimum and maximum values of the column that are present in the hash table. Subsequently, the processing engine reads the lookup or right table T2's objects whose minimum-maximum value range overlaps the hash table's minimum-maximum range, and performs the join in the hash table with the rows of the probe or left table.

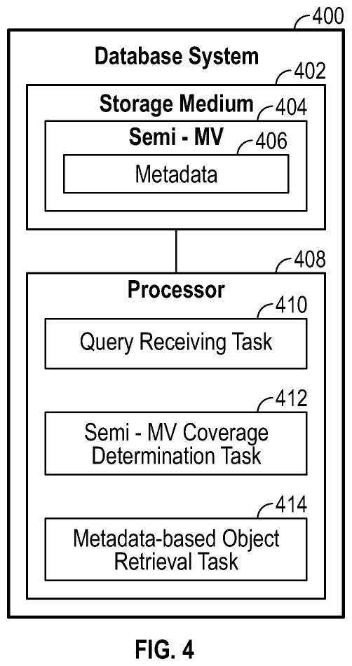

FIG. 4 is a block diagram of a database system 400 according to some examples. The DBMS 102 of FIG. 1 can be an example of the database system 400.

The database system 400 includes a storage medium 402 to store a semi-MV 404 defined on an MV condition, where the semi-MV 404 includes metadata 406 containing references to objects containing data of one or more tables that satisfy the MV condition. The objects are stored in a remote data store (e.g., 104 in FIG. 1) that is coupled to the database system 400 over a network (e.g., 108 in FIG. 1).

In some examples, the metadata 406 further includes a range of values of a column of the objects of the one or more tables, where the MV condition includes a predicate on the column.

The database system 400 further includes at least one hardware processor 408 to perform various tasks, such as based on executing machine-readable instructions. A hardware processor can include a microprocessor, a core of a multi-core microprocessor, a microcontroller, a programmable integrated circuit, a programmable gate array, or another hardware processing circuit.

The at least one hardware processor 408 can perform a query receiving task 410 to receive a database query including a query condition.

The at least one hardware processor 408 can perform a semi-MV coverage determination task 412 to determine that the semi-MV 404 can be used to satisfy the query based on the MV condition and the query condition.

The at least one hardware processor 408 a metadata-based object retrieval task 414 to use the metadata in the semi-MV 404 to retrieve data of the objects in the remote data store for the query.

In some examples, mapping information allocates different assigned value ranges of the column across respective different processing engines (e.g., 112 in FIG. 1). A first processing engine determines whether the range of values of the column included in the metadata includes values in a first assigned value range for the first processing engine, the first assigned value range allocated to the first processing engine by the mapping information. In response to determining that the range of values of the column included in the metadata includes values in the first assigned value range, the first processing engine retrieves, from the remote data store, the objects having values of the column in the first assigned value range for performing a database operation in response to the query

A non-transitory machine-readable or computer-readable storage medium that stores machine-readable instructions can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory or other type of non-volatile memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A database system comprising:
a storage medium to store a semi-materialized view (MV) defined on an MV condition, the semi-MV including metadata containing references to objects containing data of one or more tables that satisfy the MV condition, the objects stored in a remote data store that is coupled to the database system over a network; and
at least one processor to:
receive a query including a query condition;
determine that the semi-MV can be used to satisfy the query based on the MV condition and the query condition; and
use the metadata in the semi-MV to retrieve data of the objects in the remote data store for the query.

2. The database system of claim 1, wherein the references comprise information of locations of the objects.

3. The database system of claim 1, wherein the references comprise names of the objects.

4. The database system of claim 1, wherein the metadata comprises a range of values of a column of the objects of the one or more tables, the MV condition comprising a predicate on the column.

5. The database system of claim 4, comprising:
a plurality of processing engines to perform database operations in response to the query, wherein mapping information allocates different assigned value ranges of the column across respective different processing engines of the plurality of processing engines, and
wherein a first processing engine of the plurality of processing engines is to:
determine whether the range of values of the column included in the metadata includes values in a first assigned value range for the first processing engine, the first assigned value range allocated to the first processing engine by the mapping information.

6. The database system of claim 5, wherein the first processing engine is to further:
in response to determining that the range of values of the column included in the metadata includes values in the first assigned value range, retrieve, from the remote data store, the objects having values of the column in the first assigned value range for performing a database operation in response to the query.

7. The database system of claim 5, wherein the MV condition is a join condition on a plurality of tables, the plurality of tables including a first table and a second table.

8. The database system of claim 7, wherein the join condition is on the column, and the mapping information allocates the different assigned value ranges of the column in the first table across the respective different processing engines of the plurality of processing engines.

9. The database system of claim 8, wherein the first processing engine is to determine whether the range of values of the column included in the metadata includes values of the column of the second table in the first assigned value range.

10. The database system of claim 9, wherein the first processing engine is to further:
in response to determining that the range of values of the column included in the metadata includes values of the column of the second table in the first assigned value range, retrieve, from the remote data store, the objects of the second table having values of the column in the first assigned value range for performing a database operation in response to the query

11. The database system of claim 8, wherein the at least one processor is to:
sample values of the column of the first table; and
derive the mapping information based on the sampled values of the column of the first table.

12. The database system of claim 4, comprising:
a plurality of processing engines to perform database operations in response to the query, wherein mapping information allocates different assigned value ranges of the column across respective different processing engines of the plurality of processing engines,
wherein a first processing engine of the plurality of processing engines is to:
determine whether the range of values of the column included in the metadata includes values in a first assigned value range for the first processing engine, the first assigned value range allocated to the first processing engine by the mapping information,
in response to determining that the range of values of the column included in the metadata includes values in the first assigned value range, retrieve, from the remote data store, the objects having values of the column in the first assigned value range for performing a local database operation in response to the query, and
wherein a second processing engine of the plurality of processing engines is to:
determine whether the range of values of the column included in the metadata includes values in a second assigned value range for the second processing engine, the second assigned value range allocated to the second processing engine by the mapping information, and
in response to determining that the range of values of the column included in the metadata includes values in the second assigned value range, retrieve, from the remote data store, the objects having values of the column in the second assigned value range for performing a local database operation in response to the query.

13. The database system of claim 12, wherein the query is a join query, the local database operation performed by the first processing engine is a local join operation performed using a data structure in a memory of the first processing engine, and the local database operation performed by the second processing engine is a local join operation performed using a data structure in a memory of the second processing engine.

14. The database system of claim 13, wherein the local database operation performed by the first processing engine is a first hash join operation in a hash table in the memory of the first processing engine, and the local database operation performed by the second processing engine is a second hash join operation in a hash table in the memory of the second processing engine.

15. A non-transitory machine-readable storage medium comprising instructions that upon execution cause a database system to:
store a semi-materialized view (MV) defined on an MV condition, the semi-MV including metadata containing references to objects containing data of one or more tables that satisfy the MV condition, the objects stored in a remote data store that is coupled to the database system over a network, and the semi-MV not containing any data of the one or more tables that satisfy the MV condition; and
receive a query including a query condition;
determine that the semi-MV can be used to satisfy the query based on the MV condition and the query condition; and
use the metadata in the semi-MV to retrieve data of the objects in the remote data store for the query.

16. The non-transitory machine-readable storage medium of claim 15, wherein the MV condition is a join condition specified on a first table and a second table, and the semi-MV contains a plurality of rows, each respective row of the plurality of rows including one or more references to one or more objects of the first table, and one or more references to one or more objects of the second table that are to be joined with the one or more objects of the first table.

17. The non-transitory machine-readable storage medium of claim 15, wherein the metadata specifies a range of values between a minimum value and a maximum value of a column in rows of each object of the objects.

18. The non-transitory machine-readable storage medium of claim 17, wherein the database system comprises a plurality of processing engines to perform parallel database operations in response to the query, and the instructions upon execution cause the database system to:
assign rows of the objects to the plurality of processing engines based on the range of values of the column.

19. A method of a database system, comprising:
storing a semi-materialized view (MV) defined on an MV condition, the semi-MV including metadata containing references to objects containing data of one or more tables that satisfy the MV condition, the objects stored in a remote data store that is coupled to the database system over a network, and the semi-MV not containing any data of the one or more tables that satisfy the MV condition; and
receiving a query including a query condition;
determining that the semi-MV can be used to satisfy the query based on the MV condition and the query condition; and
using the metadata in the semi-MV to retrieve data of the objects in the remote data store for the query.

20. The method of claim 19, wherein the metadata comprises a range of values of a column of the objects of the one or more tables, the MV condition comprising a predicate on the column.
